(19) United States
(12) Patent Application Publication
(10) Pub. No.: US 2025/0080249 A1
(43) Pub. Date: Mar. 6, 2025

(54) MEASUREMENT OF LINKS ASSOCIATED WITH A PASSIVE DEVICE

(71) Applicant: QUALCOMM Incorporated, San Diego, CA (US)

(72) Inventors: Saeid SAHRAEI, San Diego, CA (US); Yu ZHANG, San Diego, CA (US); Hung Dinh LY, San Diego, CA (US); Krishna Kiran MUKKAVILLI, San Diego, CA (US)

(21) Appl. No.: 18/293,983

(22) PCT Filed: Oct. 7, 2021
(86) PCT No.: PCT/CN2021/122527

§ 371 Date: Jan. 31, 2024

(51) Int. Cl. H04B 17/309; H04W 24/10

(52) U.S. Cl. CPC H04B 17/309; H04W 24/10

(57) ABSTRACT

Various aspects of the present disclosure generally relate to wireless communication. In some aspects, a receiving user equipment (UE) may transmit a first measurement that is based at least in part on a first reference signal, from a base station, that is to be reflected via a passive device. The receiving UE may transmit a second measurement that is based at least in part on a second reference signal, from a transmitting UE, that is to be reflected via the passive device and a third reference signal from the transmitting UE. Numerous other aspects are described.

### FIELD OF THE DISCLOSURE

Aspects of the present disclosure generally relate to wireless communication and to techniques and apparatuses for measuring links associated with a passive device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a receiving user equipment (UE). The method may include transmitting a first measurement that is based at least in part on a first reference signal, from a base station, that is to be reflected via a passive device. The method may include transmitting a second measurement that is based at least in part on a second reference signal, from a transmitting UE, that is to be reflected via the passive device and a third reference signal from the transmitting UE.

Some aspects described herein relate to a method of wireless communication performed by a transmitting UE. The method may include transmitting a first measurement that is based at least in part on a first reference signal, from a base station, that is reflected via a passive device. The method may include transmitting, in connection with a request from the base station, a second reference signal, to a receiving UE, that is to be reflected via the passive device. The method may include transmitting, in connection with the request, a third reference signal to the receiving UE.

Some aspects described herein relate to a method of wireless communication performed by a base station. The method may include transmitting, to a transmitting UE, a first reference signal that is to be reflected via a passive device and a request for the transmitting UE to transmit, to a receiving UE, a second reference signal that is to be reflected via the passive device. The method may include transmitting, to the receiving UE, a third reference signal that is to be reflected via the passive device. The method may include receiving a first measurement from the transmitting UE for the first reference signal, a second measurement from the receiving UE for the second reference signal, and a third measurement from the receiving UE for the third reference signal. The method may include transmitting a scheduling message to the transmitting UE or the receiving UE that is based at least in part on the first measurement, the second measurement, and the third measurement.

Some aspects described herein relate to a method of wireless communication performed by a passive device. The method may include receiving, from a base station, a first reflection configuration for a first link between the base station and the passive device. The method may include performing beam sweeping to determine a second reflection configuration for a second link between the passive device and a transmitting UE and to determine a third reflection configuration for a third link between the passive device and a receiving UE. The method may include determining a fourth reflection configuration for reflection between the transmitting UE and the receiving UE based at least in part on the second reflection configuration and the third reflection configuration. The method may include reflecting, using the fourth reflection configuration, a first reference signal from the transmitting UE to the receiving UE.

Some aspects described herein relate to a receiving UE for wireless communication. The receiving UE may include a memory and one or more processors coupled to the memory. The one or more processors may be configured to transmit a first measurement that is based at least in part on a first reference signal, from a base station, that is to be reflected via a passive device. The one or more processors may be configured to transmit a second measurement that is based at least in part on a second reference signal, from a transmitting UE, that is to be reflected via the passive device and a third reference signal from the transmitting UE.

Some aspects described herein relate to a transmitting UE for wireless communication. The transmitting UE may include a memory and one or more processors coupled to the memory. The one or more processors may be configured to transmit a first measurement that is based at least in part on a first reference signal, from a base station, that is reflected via a passive device. The one or more processors may be configured to transmit, in connection with a request from the base station, a second reference signal, to a receiving UE, that is to be reflected via the passive device. The one or more processors may be configured to transmit, in connection with the request, a third reference signal to the receiving UE.

Some aspects described herein relate to a base station for wireless communication. The base station may include a memory and one or more processors coupled to the memory. The one or more processors may be configured to transmit, to a transmitting UE, a first reference signal that is to be reflected via a passive device and a request for the transmitting UE to transmit, to a receiving UE, a second reference signal that is to be reflected via the passive device. The one or more processors may be configured to transmit, to the receiving UE, a third reference signal that is to be reflected via the passive device. The one or more processors may be configured to receive a first measurement from the transmitting UE for the first reference signal, a second measurement from the receiving UE for the second reference signal, and a third measurement from the receiving UE for the third reference signal. The one or more processors may be configured to transmit a scheduling message to the transmitting UE or the receiving UE that is based at least in part on the first measurement, the second measurement, and the third measurement.

Some aspects described herein relate to a passive device for wireless communication. The passive device may include a memory and one or more processors coupled to the memory. The one or more processors may be configured to receive, from a base station, a first reflection configuration for a first link between the base station and the passive device. The one or more processors may be configured to perform beam sweeping to determine a second reflection configuration for a second link between the passive device and a transmitting UE and to determine a third reflection configuration for a third link between the passive device and a receiving UE. The one or more processors may be configured to determine a fourth reflection configuration for reflection between the transmitting UE and the receiving UE based at least in part on the second reflection configuration and the third reflection configuration. The one or more processors may be configured to reflect, using the fourth reflection configuration, a first reference signal from the transmitting UE to the receiving UE.

Some aspects described herein relate to a non-transitory computer-readable medium that stores a set of instructions for wireless communication by a receiving UE. The set of instructions, when executed by one or more processors of the receiving UE, may cause the receiving UE to transmit a first measurement that is based at least in part on a first reference signal, from a base station, that is to be reflected via a passive device. The set of instructions, when executed by one or more processors of the receiving UE, may cause the receiving UE to transmit a second measurement that is based at least in part on a second reference signal, from a transmitting UE, that is to be reflected via the passive device and a third reference signal from the transmitting UE.

Some aspects described herein relate to a non-transitory computer-readable medium that stores a set of instructions for wireless communication by a transmitting UE. The set of instructions, when executed by one or more processors of the transmitting UE, may cause the transmitting UE to transmit a first measurement that is based at least in part on a first reference signal, from a base station, that is reflected via a passive device. The set of instructions, when executed by one or more processors of the UE, may cause the transmitting UE to transmit, in connection with a request from the base station, a second reference signal, to a receiving UE, that is to be reflected via the passive device. The set of instructions, when executed by one or more processors of the transmitting UE, may cause the transmitting UE to transmit, in connection with the request, a third reference signal to the receiving UE.

Some aspects described herein relate to a non-transitory computer-readable medium that stores a set of instructions for wireless communication by a base station. The set of instructions, when executed by one or more processors of the base station, may cause the base station to transmit, to a transmitting UE, a first reference signal that is to be reflected via a passive device and a request for the transmitting UE to transmit, to a receiving UE, a second reference signal that is to be reflected via the passive device. The set of instructions, when executed by one or more processors of the base station, may cause the base station to transmit, to the receiving UE, a third reference signal that is to be reflected via the passive device. The set of instructions, when executed by one or more processors of the base station, may cause the base station to receive a first measurement from the transmitting UE for the first reference signal, a second measurement from the receiving UE for the second reference signal, and a third measurement from the receiving UE for the third reference signal. The set of instructions, when executed by one or more processors of the base station, may cause the base station to transmit a scheduling message to the transmitting UE or the receiving UE that is based at least in part on the first measurement, the second measurement, and the third measurement.

Some aspects described herein relate to a non-transitory computer-readable medium that stores a set of instructions for wireless communication by a passive device. The set of instructions, when executed by one or more processors of the passive device, may cause the passive device to receive, from a base station, a first reflection configuration for a first link between the base station and the passive device. The set of instructions, when executed by one or more processors of the passive device, may cause the passive device to perform beam sweeping to determine a second reflection configuration for a second link between the passive device and a transmitting UE and to determine a third reflection configuration for a third link between the passive device and a receiving UE. The set of instructions, when executed by one or more processors of the passive device, may cause the passive device to determine a fourth reflection configuration for reflection between the transmitting UE and the receiving UE based at least in part on the second reflection configuration and the third reflection configuration. The set of instructions, when executed by one or more processors of the passive device, may cause the passive device to reflect, using the fourth reflection configuration, a first reference signal from the transmitting UE to the receiving UE.

Some aspects described herein relate to an apparatus for wireless communication. The apparatus may include means for transmitting a first measurement that is based at least in part on a first reference signal, from a base station, that is to be reflected via a passive device. The apparatus may include means for transmitting a second measurement that is based at least in part on a second reference signal, from another apparatus, that is to be reflected via the passive device and a third reference signal from the other apparatus.

Some aspects described herein relate to an apparatus for wireless communication. The apparatus may include means for transmitting a first measurement that is based at least in part on a first reference signal, from a base station, that is reflected via a passive device. The apparatus may include means for transmitting, in connection with a request from the base station, a second reference signal, to another apparatus, that is to be reflected via the passive device. The apparatus may include means for transmitting, in connection with the request, a third reference signal to the other apparatus.

Some aspects described herein relate to an apparatus for wireless communication. The apparatus may include means for transmitting, to a transmitting UE, a first reference signal that is to be reflected via a passive device and a request for the transmitting UE to transmit, to a receiving UE, a second reference signal that is to be reflected via the passive device. The apparatus may include means for transmitting, to the receiving UE, a third reference signal that is to be reflected via the passive device. The apparatus may include means for receiving a first measurement from the transmitting UE for the first reference signal, a second measurement from the receiving UE for the second reference signal, and a third measurement from the receiving UE for the third reference signal. The apparatus may include means for transmitting a scheduling message to the transmitting UE or the receiving UE that is based at least in part on the first measurement, the second measurement, and the third measurement.

Some aspects described herein relate to an apparatus for wireless communication. The apparatus may include means for receiving, from a base station, a first reflection configuration for a first link between the base station and the apparatus. The apparatus may include means for performing beam sweeping to determine a second reflection configuration for a second link between the apparatus and a transmitting UE and to determine a third reflection configuration for a third link between the passive device and a receiving UE. The apparatus may include means for determining a fourth reflection configuration for reflection between the transmitting UE and the receiving UE based at least in part on the second reflection configuration and the third reflection configuration. The apparatus may include means for reflecting, using the fourth reflection configuration, a first reference signal from the transmitting UE to the receiving UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using a passive device, in accordance with the present disclosure.

FIG. 4 is a diagram illustrating an example of beam sweeping, in accordance with the present disclosure.

FIG. 5 is a diagram illustrating an example of measuring links associated with a passive device, in accordance with the present disclosure

FIG. 6 is a diagram illustrating an example of determining an accurate measurement, in accordance with the present disclosure.

FIG. 7 is a diagram illustrating an example of measuring links associated with a passive device, in accordance with the present disclosure.

FIG. 8 is a diagram illustrating an example of measuring links associated with a passive device, in accordance with the present disclosure.

FIG. 9 is a diagram illustrating an example process performed, for example, by a receiving UE, in accordance with the present disclosure.

FIG. 10 is a diagram illustrating an example process performed, for example, by a transmitting UE, in accordance with the present disclosure.

FIG. 11 is a diagram illustrating an example process performed, for example, by a base station, in accordance with the present disclosure.

FIG. 12 is a diagram illustrating an example process performed, for example, by a passive device, in accordance with the present disclosure.

FIGS. 13-16 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

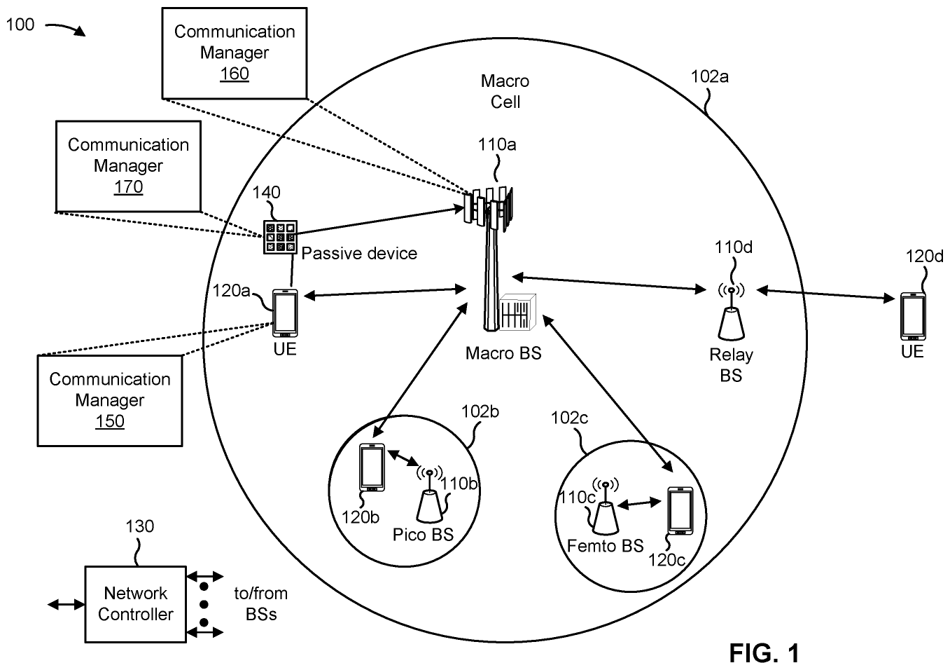

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller may couple to a set of BSs and may provide coordination and control for these BSs. The network controller may communicate with the BSs via a backhaul. The BSs may also communicate with one another directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V₂I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHZ, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHZ). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHZ). It is contemplated that the frequencies included in FR1 and FR2 may be modified, and techniques described herein are applicable to those modified frequency ranges.

Wireless network 100 shows a first device (e.g., UE 120a, base station 110) that may communicate with a second device (e.g., base station 110, UE 120a) directly or by reflecting signals via a passive device 140 (e.g., a reconfigurable intelligent surface (RIS)). The first device may be a transmitting UE and the second device may be a receiving UE, because the transmitting UE is transmitting a reference signal to the receiving UE. This may be at the request of the base station.

In some aspects, a receiving UE (e.g., UE 120) may include a communication manager 150. As described in more detail elsewhere herein, the communication manager 150 may transmit a first measurement that is based at least in part on a first reference signal, from a base station, that is to be reflected via a passive device. The communication manager 150 may transmit a second measurement that is based at least in part on a second reference signal, from a transmitting UE, that is to be reflected via the passive device and a third reference signal from the transmitting UE. Additionally, or alternatively, the communication manager 150 may perform one or more other operations described herein.

In some aspects, the transmitting UE (e.g., UE 120) may include a communication manager 150. As described in more detail elsewhere herein, the communication manager 150 may transmit a first measurement that is based at least in part on a first reference signal, from a base station, that is reflected via a passive device. The communication manager 150 may transmit, in connection with a request from the base station, a second reference signal, to a receiving UE, that is to be reflected via the passive device. The communication manager 150 may transmit, in connection with the request, a third reference signal to the receiving UE. Additionally, or alternatively, the communication manager 150 may perform one or more other operations described herein.

In some aspects, the base station 110 may include a communication manager 160. As described in more detail elsewhere herein, the communication manager 160 may transmit, to a transmitting UE, a first reference signal that is to be reflected via a passive device and a request for the transmitting UE to transmit, to a receiving UE, a second reference signal that is to be reflected via the passive device. The communication manager 160 may transmit, to the receiving UE, a third reference signal that is to be reflected via the passive device. The communication manager 160 may receive a first measurement from the transmitting UE for the first reference signal, a second measurement from the receiving UE for the second reference signal, and a third measurement from the receiving UE for the third reference signal. The communication manager 160 may transmit a scheduling message to the transmitting UE or the receiving UE that is based at least in part on the first measurement, the second measurement, and the third measurement. Additionally, or alternatively, the communication manager 160 may perform one or more other operations described herein.

In some aspects, the passive device 140 may include a communication manager 170. As described in more detail elsewhere herein, the communication manager 170 may receive, from a base station, a first reflection configuration for a first link between the base station and the passive device and perform beam sweeping to determine a second reflection configuration for a second link between the passive device and a transmitting UE and to determine a third reflection configuration for a third link between the passive device and a receiving UE. The communication manager 170 may determine a fourth reflection configuration for reflection between the transmitting UE and the receiving UE based at least in part on the second reflection configuration and the third reflection configuration. The communication manager 170 may reflect, using the fourth reflection configuration, a first reference signal from the transmitting UE to the receiving UE. Additionally, or alternatively, the communication manager 170 may perform one or more other operations described herein.

As indicated above, FIG. 1 is provided as an example. Other examples may differ from what is described with regard to FIG. 1.

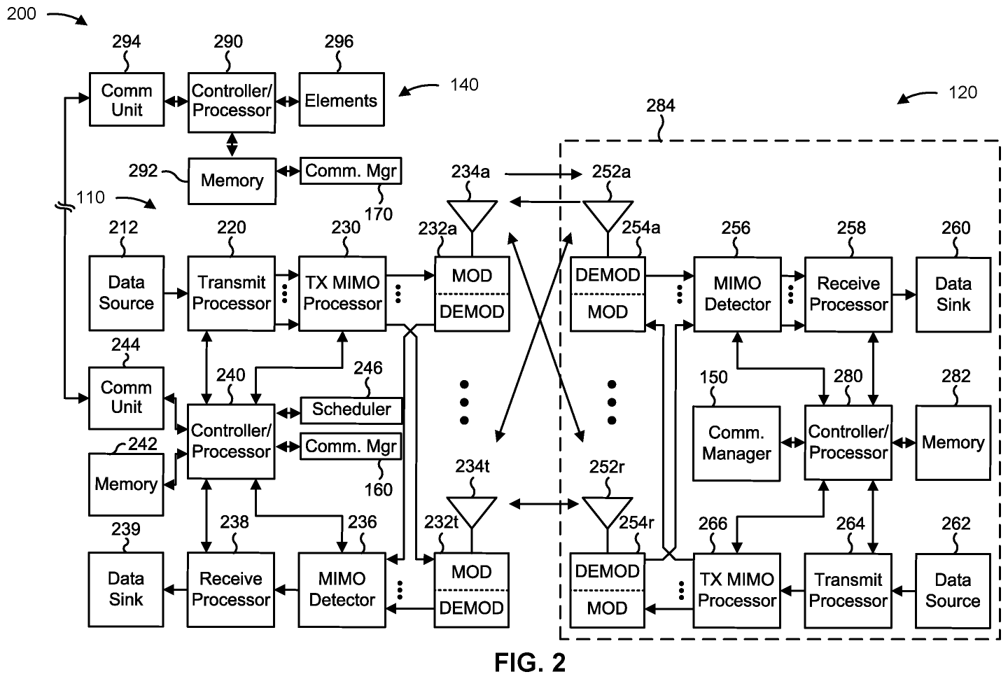

FIG. 2 is a diagram illustrating an example 200 of a base station 110 in communication with a UE 120 in a wireless network 100, in accordance with the present disclosure. The base station 110 may be equipped with T antennas 234a through 234t, and the UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of the UE 120 may be included in a housing 284.

The passive device 140 may include communication unit 294, controller/processor 290, memory 292, and surface elements 296. The controller/processor 290 may control a configuration (e.g., reflective direction) of the surface elements 296 by applying voltage to specific elements of the surface elements 296. The passive device 140 may communicate with the base station 110 via the communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

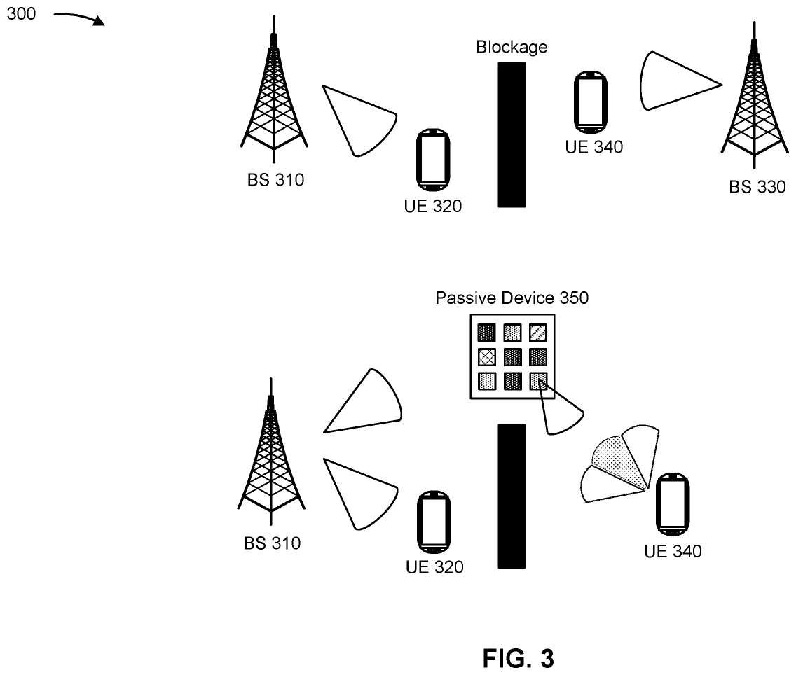

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-16).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-16).

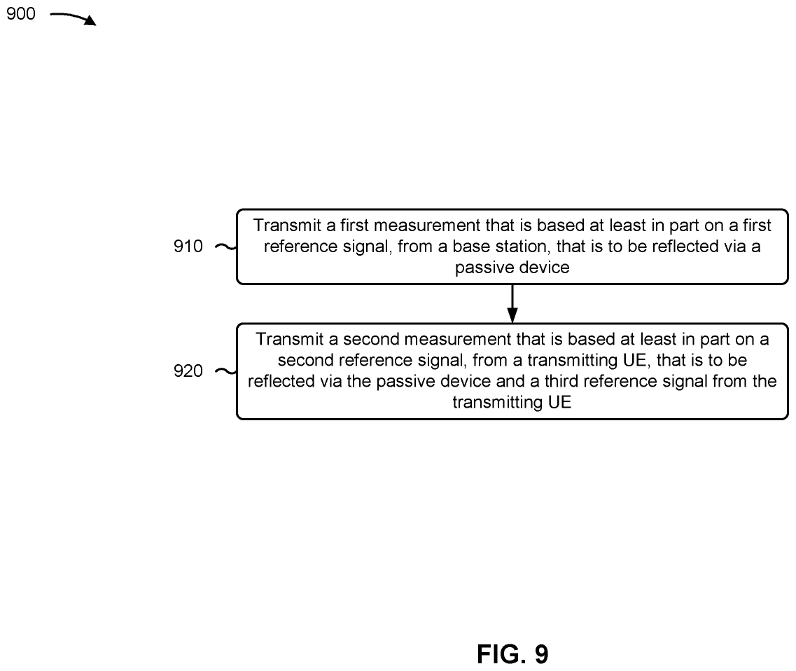

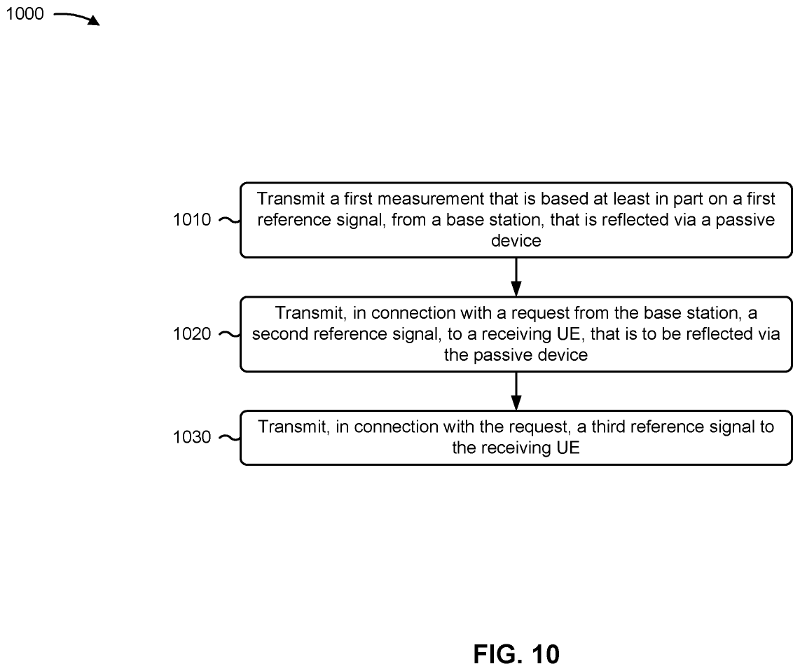

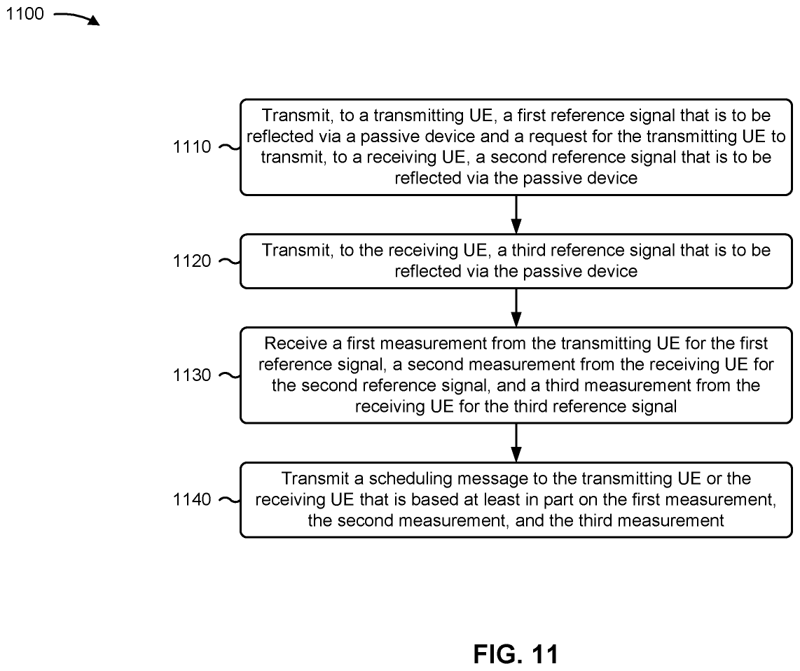

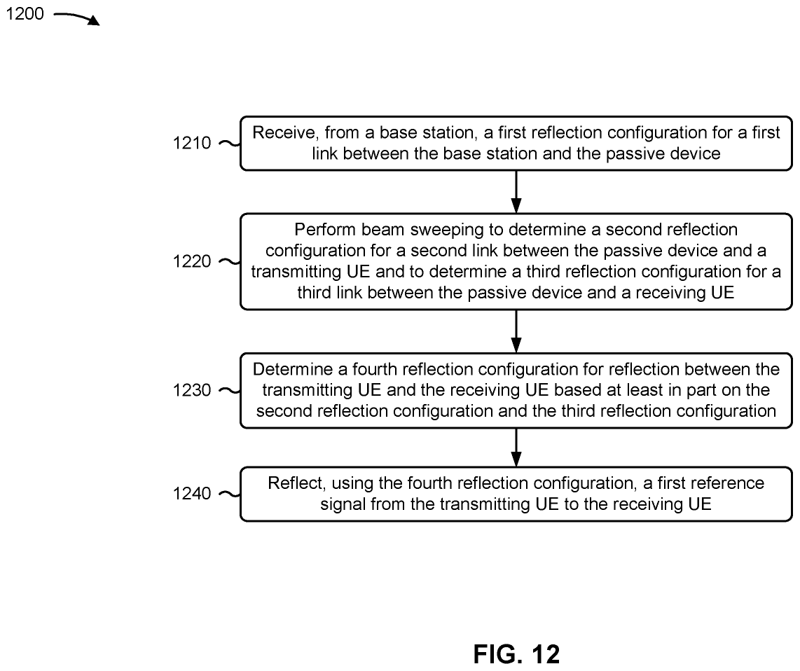

Controller/processor 240 of the base station 110, controller/processor 280 of the UE 120, controller/processor 290 of the passive device 140, and/or any other component(s) of FIG. 2 may perform one or more techniques associated with measuring links associated with a passive device, as described in more detail elsewhere herein. For example, controller/processor 240 of base station 110, controller/processor 280 of the UE 120, controller/processor 290 of the passive device 140, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. Memories 242, 282, and 292 may store data and program codes for the base station 110, the UE 120, and the passive device 140, respectively. In some aspects, memory 242, memory 282, and/or memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110, the passive device 140, and/or the UE 120 may cause the one or more processors, the base station 110, the passive device 140, and/or the UE 120 to perform or direct operations of, for example, process 900 of FIG. 9, process 1000 of FIG. 10, process 1100 of FIG. 11, process 1200 of FIG. 12, and/or other processes as described herein. In some aspects, executing instructions may include running the instructions, converting the instructions, compiling the instructions, and/or interpreting the instructions, among other examples.

In some aspects, a receiving UE (e.g., UE 120) includes means for transmitting a first measurement that is based at least in part on a first reference signal, from a base station, that is to be reflected via a passive device; and/or means for transmitting a second measurement that is based at least in part on a second reference signal, from a transmitting UE, that is to be reflected via the passive device and a third reference signal from the transmitting UE. The means for the receiving UE to perform operations described herein may include, for example, one or more of communication manager 150, antenna 252, modem 254, MIMO detector 256, receive processor 258, transmit processor 264, TX MIMO processor 266, controller/processor 280, or memory 282.

In some aspects, a transmitting UE (e.g., UE 120) includes means for transmitting a first measurement that is based at least in part on a first reference signal, from a base station, that is reflected via a passive device; means for transmitting, in connection with a request from the base station, a second reference signal, to a receiving UE, that is to be reflected via the passive device; and/or means for transmitting, in connection with the request, a third reference signal to the receiving UE. The means for the transmitting UE to perform operations described herein may include, for example, one or more of communication manager 150, antenna 252, modem 254, MIMO detector 256, receive processor 258, transmit processor 264, TX MIMO processor 266, controller/processor 280, or memory 282.

In some aspects, the base station 110 includes means for transmitting, to a transmitting UE, a first reference signal that is to be reflected via a passive device and a request for the transmitting UE to transmit, to a receiving UE, a second reference signal that is to be reflected via the passive device; means for transmitting, to the receiving UE, a third reference signal that is to be reflected via the passive device; means for receiving a first measurement from the transmitting UE for the first reference signal, a second measurement from the receiving UE for the second reference signal, and a third measurement from the receiving UE for the third reference signal; and/or means for transmitting a scheduling message to the transmitting UE or the receiving UE that is based at least in part on the first measurement, the second measurement, and the third measurement. The means for the base station 110 to perform operations described herein may include, for example, one or more of communication manager 160, transmit processor 220, TX MIMO processor 230, modem 232, antenna 234, MIMO detector 236, receive processor 238, controller/processor 240, memory 242, or scheduler 246.

In some aspects, the passive device includes means for receiving, from a base station, a first reflection configuration for a first link between the base station and the passive device; means for performing beam sweeping to determine a second reflection configuration for a second link between the passive device and a transmitting UE and to determine a third reflection configuration for a third link between the passive device and a receiving UE; means for determining a fourth reflection configuration for reflection between the transmitting UE and the receiving UE based at least in part on the second reflection configuration and the third reflection configuration; and/or means for reflecting, using the fourth reflection configuration, a first reference signal from the transmitting UE to the receiving UE. In some aspects, the means for the passive device to perform operations described herein may include, for example, one or more of communication manager 170, communication unit 294, controller/processor 290, memory 292, or surface elements 296.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIG. 3 is a diagram illustrating an example 300 of using a passive device, in accordance with the present disclosure. Example 300 shows a base station 310 (e.g., BS 110) that may communicate with a UE 320 (e.g., UE 120), and a BS 330 (e.g., BS 110) that may communicate with UE 340 (e.g., UE 120).

A network may have antennas that are grouped together at a transmitter or receiver, in order to increase throughput. The grouping of antennas may be referred to as “massive MIMO.” Massive MIMO may use active antenna units (AAUs) to achieve high beamforming gain. An AAU may combine an antenna, a radio, a tower-mounted amplifier, a feeder, and/or jumper functionalities into a single unit. An AAU may include an individual radio frequency (RF) chain for each antenna port.

There may be barriers to massive MIMO. The transmission of signals may be blocked by buildings, natural topography, or other blocking structures. For example, BS 310 may transmit signals to UE 320, but BS 310 may not able to transmit signals to UE 340. As shown in example 300, there is some type of blockage between BS 310 and UE 340. UE 340 may instead be served by BS 330.

In order to resolve transmission issues due to the blockage, the network may use a passive device 350 (e.g., passive device 140). The passive device 350 may be a device that forwards, relays, repeats, or reflects in a passive or near passive manner. The passive device 350 may be configured as a RIS. A RIS may be a two-dimensional surface of engineered material whose properties are reconfigurable rather than static. The engineered material may contain integrated electronic circuits and software that enable the control of a wireless medium by altering an impedance of the surface or a portion of the surface. The change in impedance may alter a phase shift and/or an angle of reflection. Scattering, absorption, reflection, and diffraction properties may be changed with time and controlled by the software. A RIS may act as a reflective lens. In one example, a RIS may include large arrays of inexpensive antennas spaced half of a wavelength apart. In another example, a RIS may include metamaterial-based planar or conformal large surfaces whose elements (e.g., square elements) have sizes and inter-distances that are smaller than the wavelength. Each of the elements may have a configured impedance or other surface properties that are controlled by a voltage to the element. A RIS may also be referred to as a “software-controlled metasurface” or an “intelligent reflecting surface”.

The passive device 350, when configured to operate as a RIS, may not have antennas or RF chains of its own, but may include a large number of small, low-cost elements on a surface to passively reflect incident signals transmitted from BS 310. A controller of the passive device 350 may control the elements on the surface. The passive device 350 may be a smart device that is configured to use a specific angle of reflection for the signals. BS 310 may control, as part of a reflective configuration, the angle of reflection (angle of arrival, angle of departure), an amplitude, a weight, a phase, and/or a width of the elements of the passive device 350 by controlling a voltage to each of the elements. The reflective configuration may also correspond to reflecting weights or coefficients that are provided by the passive device when reflecting signals from one device to another. The reflective configuration may also be referred to as an “RIS reflection configuration,” an “RIS reflection matrix,” or a “P-MIMO configuration.” In sum, the passive device 350 may help to control a propagation environment with less power consumption than AAUs. Passive devices may even replace AAUs in the propagation environment. MIMO that uses passive devices may be referred to as “passive MIMO” or “P-MIMO”. The passive device 350 may be also referred to as a “passive node” or a “P-MIMO device”

In some aspects, BS 310 may configure the passive device 350 by sending a control signal with information for configuring the properties and/or timing of the elements. For example, BS 310 may transmit a set of beam weights to the passive device 350 through explicit signaling (e.g., radio resource control (RRC) signaling) instead of using beam sweeping. However, the passive device 350 may not provide any feedback to the BS 310 as to whether the control signal from the BS 310 is successfully received. If the passive device 350 does not successfully receive the control signal or successfully reconfigure properties of the passive device 350, the BS 310 and other UEs may process with using the passive device for reflecting signals that will be not be properly reflected in the expected directions. Improperly reflected signals will degrade communications, and degraded communications may cause UE 340 and BS 310 to consume additional processing resources and signaling resources with retransmissions.

In some aspects, the BS 310 may transmit a control signal to the passive device 350 for operation of the passive device, and the passive device 350 may provide information back to the BS 310. For example, the passive device 350 may provide a few bits of RIS-side information, such as an indication of an acknowledgement (ACK) or a negative acknowledgment (NACK) of the control signal. The information may also indicate quality of the channel. However, if the passive device 350 is not configured for indicating channel information about individual links, the BS 310 may schedule messages without information about which links that may be blocked or interfered with. This may cause communications to degrade, which wastes processing resources and signaling resources.

For example, the BS 310 may detect an issue when communicating with the UE 340 via the passive device 350. However, the BS 310 does not know whether there is an issue with the link between the BS 310 and the passive device 350 or the link between the passive device 350 and the UE 340. The BS 310 only knows that there is an issue somewhere along the links between the BS 310 and the UE 340. For example, the BS 310 may receive a signal from the UE 340 that is reflected via the passive device 350. The BS 310 may determine a path loss of the received signal by measuring the strength of the received signal relative to the strength of a transmitted signal. The distance to the UE 340 may also be a factor. The BS 310 may determine that there is a large path loss or block between the BS 310 and the UE 340. However, the BS 310 does not know whether the large path loss occurs on the link between the BS 310 and the passive device 350 or on the link between the passive device 350 and the UE 340. The BS 310 is only able to measure the received signal over the aggregate of the links between the BS 310 and the UE 340.

Furthermore, each link between the devices may have a rank, which may correspond to a quantity of data streams for the link. For example, a rank of 1 has 1 data stream (layer), while a rank of 4 has 4 data streams. If communication between the BS 310 and the UE 340 has a lower than expected rank, the BS 310 may not know which link is the bottleneck or is responsible for the lower rank.

As indicated above, FIG. 3 is provided as an example. Other examples may differ from what is described with regard to FIG. 3.

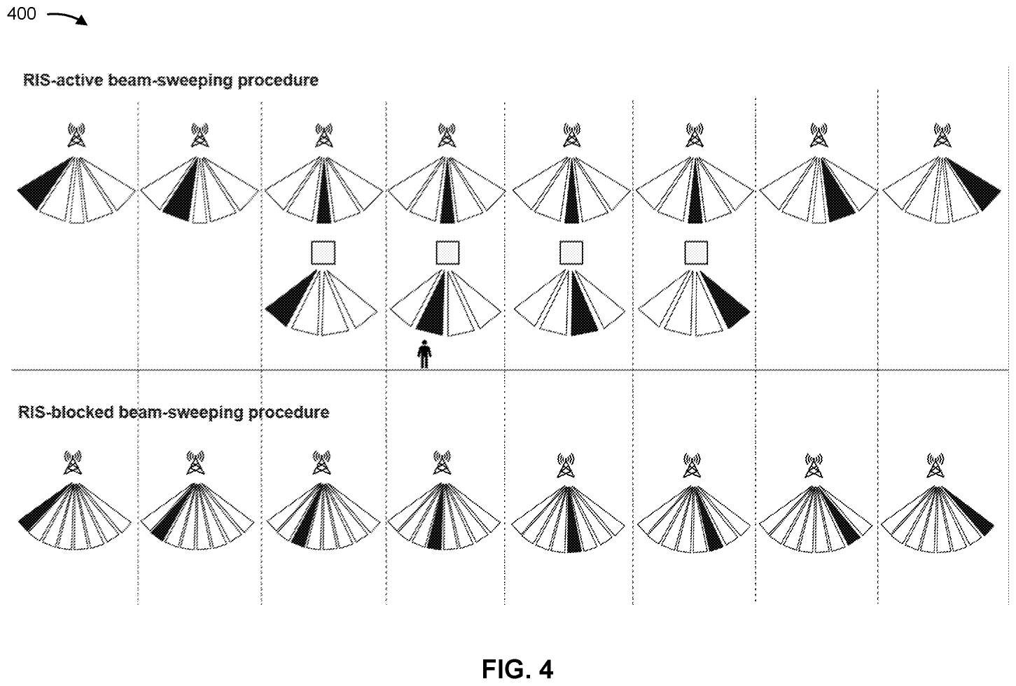

FIG. 4 is a diagram illustrating an example 400 of beam sweeping, in accordance with the present disclosure.

If the BS 310 is not able to determine which link in an aggregate of links is suffering a large path loss, the BS 310 may consume more signaling resources than necessary when beam sweeping. Example 400 shows that the BS 310 may perform a beam sweep, and an active RIS (e.g., passive device 350) that is in a beam direction of the BS 310 may also perform a beam sweep. Because the BS 310 is using multiple beam sweep instances in a single direction towards the RIS in order for the RIS to perform a beam sweep, BS 310's beams in the directions of other beam sweep instances may be wider in order to cover the area (see top portion of example 400). Wider beams have less directional energy per targeted device. If there is no active RIS, BS 310's beams may be narrower, have more targeted energy, and consume less signaling resources (see bottom portion of example 400). In other words, if the BS 310 is not able to determine that the link between the BS 310 and the RIS is suffering the large path loss, the BS 310 may continue using the RIS when the resource costs outweigh the benefits. If the link to the RIS is blocked, it is better that the BS 310 does not direct multiple beam sweep instances at the RIS.

As indicated above, FIG. 4 is provided as an example. Other examples may differ from what is described with regard to FIG. 4.

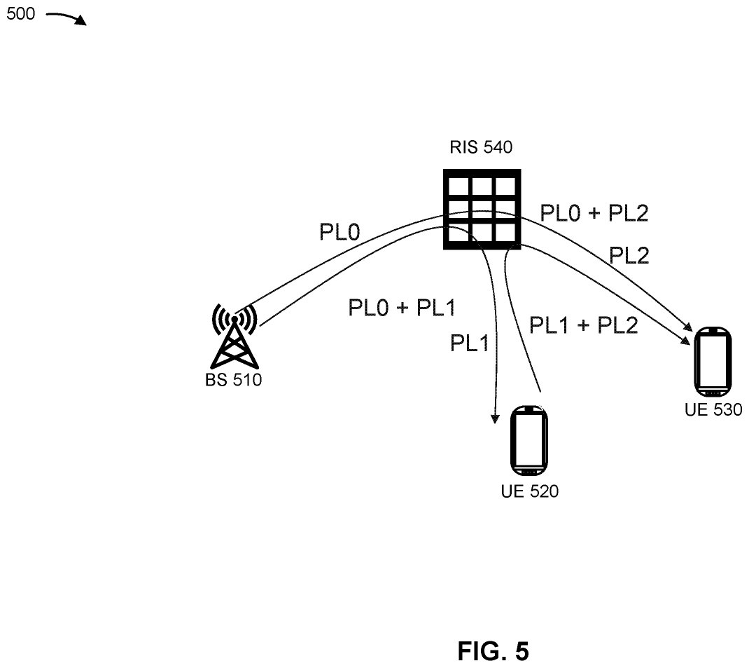

FIG. 5 is a diagram illustrating an example 500 of measuring links associated with a passive device, in accordance with the present disclosure. A base station 510 (e.g., BS 110, BS 310) may communicate with a UE 520 (e.g., UE 120, UE 340) or a UE 530 (e.g., UE 120, UE 340) via a passive device, such as a RIS 540 (e.g., passive device 350). UE 520 may be referred to as a “transmitting UE” as UE 520 may be configured to transmit a reference signal to UE 530, which may be a “receiving UE” as UE 530 may be configured to receive the reference signal from UE 520.

According to various aspects described herein, the base station 510 may determine a path loss for individual links associated with the RIS 540. The base station 510 may transmit a first reference signal to the 520 via the RIS 540 for a first measurement by UE 520 (PL0+PL1). The base station 510 may also transmit a request that UE 520 transmit a second reference signal to UE 530 via the RIS 540 (PL1+PL2). UE 530 may obtain a second measurement based at least in part on the second reference signal. The base station 510 may transmit a third reference signal to UE 530 via the RIS 540 for a third measurement by UE 530 (PL0+PL2). UE 520 may transmit the first measurement to the base station 510. UE 530 may transmit the second measurement and the third measurement to the base station 510. If the measurements are path losses, the base station 510 may determine the path loss (PL0) of a link to the RIS 540, the path loss (PL1) of a link between the RIS 540 and UE 520, and the path loss (PL2) of a link between the RIS 540 and UE 530 based at least in part on the first measurement, the second measurement, and the third measurement. That is, the base station 510 may solve equations involving PL0+PL1, PL1+PL2, and PL0+PL2 to obtain the values of PL0, PL1, and PL2.

If the base station 510 determines that the link between the base station 510 and the RIS 540 is blocked, the base station 510 may not repeat a beam, such as a synchronization signal block (SSB) beam, to the RIS 540. The base station 510 may also transmit a scheduling message to UE 520 or UE 530 that is based at least in part on the path losses that the base station 510 determined. The base station 510 may also optimize a configuration of the RIS 540. By determining a path loss for each individual link, the base station 510, UE 520, UE 530, and/or the RIS 540 may improve communications and conserve processing resources and signaling resources.

As indicated above, FIG. 5 is provided as an example. Other examples may differ from what is described with regard to FIG. 5.

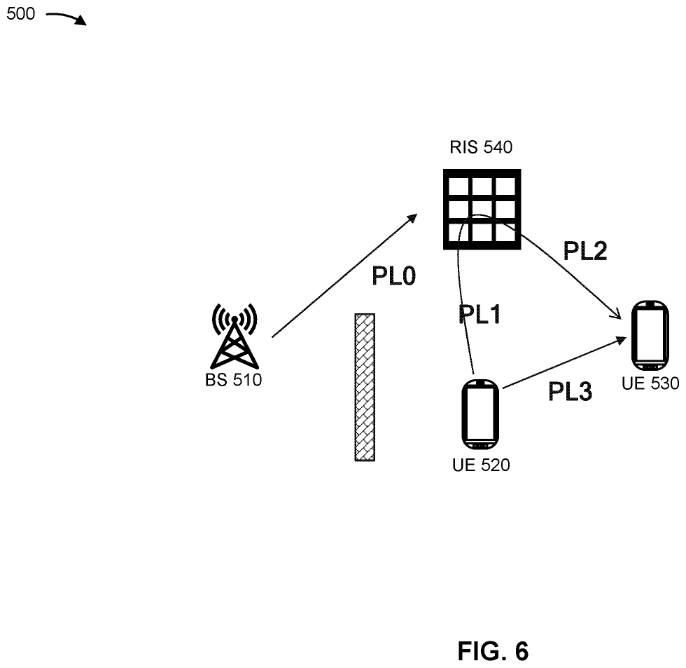

FIG. 6 is a diagram illustrating an example 600 of determining an accurate measurement, in accordance with the present disclosure.

In some scenarios, the RIS 540 may be configured to operate in an area where signals between the base station 510 and UE 520 or UE 530 are blocked. Communications to UE 530 via the RIS 540 (PL1+PL2) may be affected by a stronger, non-reflected line of sight (LoS) reference signal from the UE 520 (PL3). UE 530 may subtract a reference signal corresponding to PL3 from a reference signal transmitted via the RIS 540 (PL1+PL2) when obtaining the second measurement. UE 520, UE 530, and/or the RIS 540 may coordinate so as to distinguish the reference signal over PL1+PL2 from the reference signal over PL3. For example, UE 520 may transmit two reference signals on two consecutive symbols (or time slots). The RIS 540 may be activated for the first symbol and deactivated for the second symbol, or the RIS 540 may be deactivated for the first symbol and activated for the second symbol.

Alternatively, the RIS 540 may apply a marking to one of the reference signals and UE 520 may transmit both reference signals in one symbol. For example, the RIS 540 may apply a watermarking frequency shift to one of the two reference signals. UE 530 may use the watermarking frequency shift to distinguish the reference signal over PL1+PL2 from the reference signal over PL3.

In some aspects, the RIS 540 may configure a third RIS reflection configuration (matrix) between UE 520 and UE 530 based at least in part on a first RIS reflection configuration from the base station 510 to the RIS 540 and from the RIS 540 to UE 520 (V1=V_{gnb-ris}×Vᵣᵢₛ₋ᵤₑ₁) and a second RIS reflection configuration from the base station 510 to the RIS 540 and from the RIS 540 to UE 530 (V2=V_{gnb-ris}×Vᵣᵢₛ₋ᵤₑ₂). The first component V_{gnb-ris} may be fixed based at least in part on the LoS channel between the base station 510 and the RIS 540. The base station 510 may compute the second component Vᵣᵢₛ₋ᵤₑ₁ or Vᵣᵢₛ₋ᵤₑ₂ individually for UE 520 and UE 530 based at least in part on beam-sweeping. The RIS 540 may compute the third reflection configuration V3=Vᵣᵢₛ₋ᵤₑ₁×Vᵣᵢₛ₋ᵤₑ₂ based at least in part on the first reflection configuration V1 and the second reflection configuration V2. In other words, the RIS 540 may determine an optimal configuration between UE 520 and UE 530 without a third beam sweep from UE 520 to UE 530.

Furthermore, there may be some loss of energy of a reference signal due to reflection via the RIS 540. The RIS reflection loss RI can be modeled as a function ƒ(θ_{inc}) of an angle θ_{inc} that the RIS 540 receives the reference signal and a function ƒ(θ_{ref}) of an angle of reflection θ_{ref}. Without a loss of generality, if the RIS reflection loss is modeled as RL(θ_{inc}, θ_{ref})=ƒ(θ_{inc})×ƒ(θ_{ref}), the base station 510 may determine the reflection loss at the RIS 540, in addition to the path loss of each link. Alternatively, the base station 510 may approximate the RIS reflection loss based at least in part on the SSB beam index selected by each UE.

As indicated above, FIG. 6 is provided as an example. Other examples may differ from what is described with regard to FIG. 6.

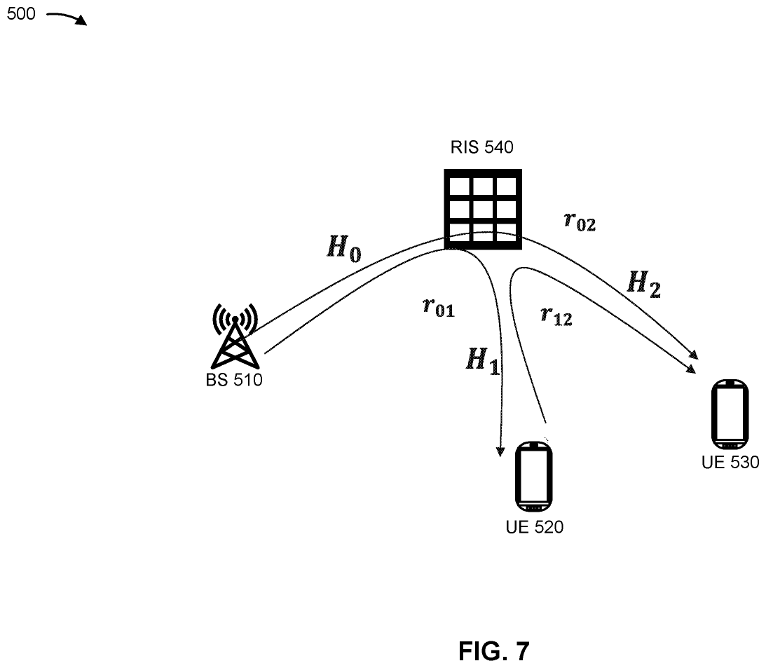

FIG. 7 is a diagram illustrating an example 700 of measuring links associated with a passive device, in accordance with the present disclosure. The base station 510 may communicate with the UE 520 and/or the UE 530 via the RIS 540 using the same rank or different ranks. UE 520 may be the transmitting UE, and UE 530 may be the receiving UE.

In some aspects, the base station 510 may obtain measurements that are rank determinations and calculate ranks of individual links. In this way, the base station 510 may schedule messages based at least in part on ranks of the links, or knowing which link is limiting the rank for an aggregate of links. For example, if the link between the base station 510 and the RIS 540 is a high rank (e.g., Rank 4 or higher), the base station 510 may perform multi-user MIMO via the RIS 540. If the rank is a low rank (e.g., Rank 1), the UE 520 and the UE 530 may use a simplified channel station information (CSI) report.

For example, similar to the path loss measurements described in connection with FIG. 5, the base station 510 may transmit reference signals to UE 520 and UE 530, and UE 520 may transmit a reference signal (or two reference signals) to UE 530.

A path for a first reference signal from the base station 510 to UE 520 may be represented by H₀Φ₁H₁, where H₀ represents the link from the base station 510 and the RIS 540, H₁ represents the link from the RIS 540 to the UE 520, and Φ₁ may be a reflective configuration for the RIS 540 for reflecting the first reference signal from the base station 510 to UE 520. H₂ represents the link between the RIS 540 and UE 530. Φ₂ may be a reflective configuration for the RIS 540 for reflecting the first reference signal from the base station 510 to UE 530.

Each link may have a rank r that is determined by UE 520 or UE 530. For example, UE 520 may transmit a rank determination r₀₁ for the links H₀ and H₁. The rank r₀₁ may be a minimum rank from among the rank of the link H₀ (r(H₀)) and the rank of the link H₁ (r(H₁)). This may be represented as r₀₁=Min {r(H₀), r(H₁)}. UE 530 may transmit a rank determination r₁₂ for the links H₁ and H₂, where r₀₂=Min {r(H₀), r(H₂)} and a rank determination r₀₂ for links H₀ and H₂, where r₁₂=Min {r(H₁), r(H₂)}. UE 520 and UE 530 may report a rank determination as a rank indicator (RI). In some aspects, the UE 530 may determine the rank r₁₂ by subtracting one reference signal from another, where the signals are distinguished in time or frequency, as described in connection with FIG. 6. Subtracting the one reference signal from the other reference signal may include subtracting an energy value of the one reference signal to isolate the other reference signal.

The base station 510 may infer useful information about individual links from the reported rank determinations. For example, if r₀₁=r₀₂<r₁₂, then the base station 510 may determine that the link H₀ between the base station 510 and the RIS 540 is the bottleneck and r(H₀)=r₀₁=r₀₂. If r₀₁=r₁₂<r₀₂, then the base station 510 may determine that the link H₁ between the RIS 540 and the UE 320 is the bottleneck rather than link H₀. In some aspects, a rank determination may be partially based on an RSRP.

In some aspects, UE 520 and UE 530 may use another procedure for reporting the physical rank of a channel. UE 520 may be configured with a threshold ratio α (e.g., via an RRC configuration). UE 520 may report the greatest integer i that satisfies ratio of eigenvalues

$$\frac{{λ}_{i}}{{λ}_{1}} \geq α ,$$

where λᵢ is the i'th largest singular value or eigenvalue (energy measurement), λ₁ is an eigenvalue for the first layer of a link, λ₂ is an eigenvalue for the second layer of the link, and so forth. For example, if α=0.1 and UE 520 measures λ₁=1, λ₂=0.5, λ₃=0.05, λ₄= . . . l, UE 520 may compare

$$\frac{{λ}_{2}}{{λ}_{1}}$$

against α: 0.5/l>0.1 to arrive at a rank of at least 2. UE 520 may compare

$$\frac{{λ}_{3}}{{λ}_{1}}$$

against α: 0.05/l<0.1 such that the rank is less than 3. Accordingly, UE 520 may transmit a rank determination of Rank 2.

In another example, α=0.1 and UE 520 measures λ₁=1, λ₂=0.5, λ₃=0.2, λ₄=0.02. UE 520 compares

$$\frac{{λ}_{2}}{{λ}_{1}}$$

against α: 0.5/l>0.1 to arrive at a rank of at least 2. UE 520 compares

$$\frac{{λ}_{3}}{{λ}_{1}}$$

against α: 0.2/l>0.1, to arrive at a rank of at least 3. UE 520 compares

$$\frac{{λ}_{4}}{{λ}_{1}}$$

against α: 0.04/l<0.1 and thus the rank is less than 4. Accordingly, UE 520 may transmit a rank determination of 3. By reporting the rank of each path, UE 520 and UE 530 may assist the base station 510 with determining a rank for each individual link. This may help the base station 510 to determine how to schedule traffic over the links using (or not using) the RIS 540. This will help to improve communications and conserve processing resources and signaling resources.

As indicated above, FIG. 7 is provided as an example. Other examples may differ from what is described with regard to FIG. 7.

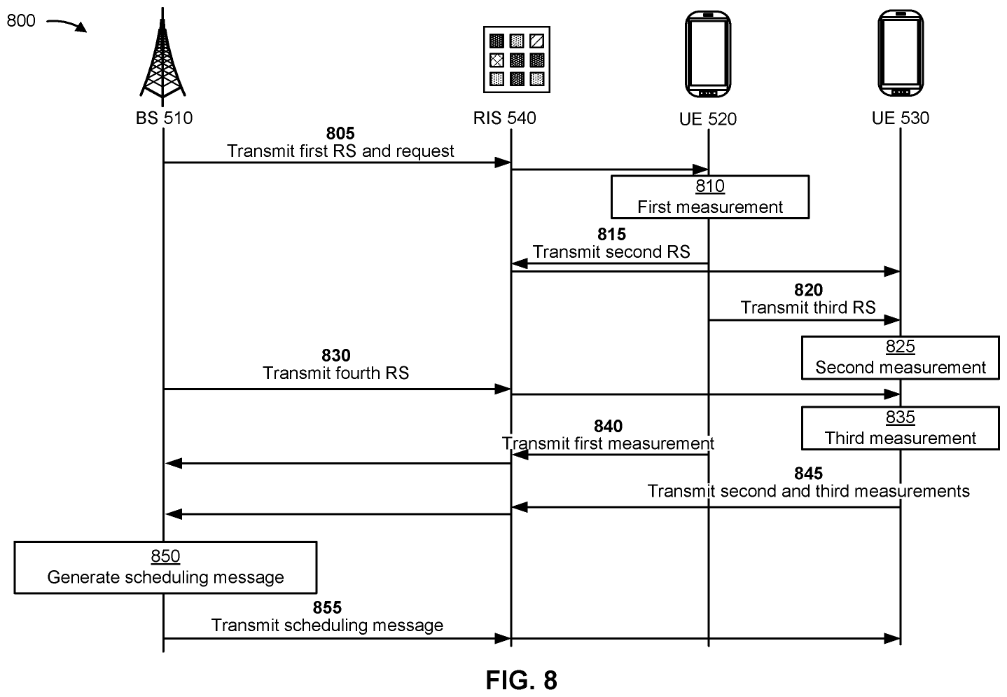

FIG. 8 is a diagram illustrating an example 800 of measuring links associated with a passive device, in accordance with the present disclosure. Example 800 shows the BS 510, UE 520, and UE 530 that may communicate with each other via one or more passive devices, such as via RIS 540. The communication may be in a wireless network, such as in wireless network 100.

As shown by reference number 805, the base station 510 may transmit a first reference signal (first RS) to UE 520 via the RIS 540. As shown by reference number 810, UE 520 may obtain a first measurement. The first measurement may be a path loss measurement or a rank determination, among other examples.

The base station 510 may also transmit a request that UE 520 transmit a second reference signal to UE 530. As shown by reference number 815, UE 520 may transmit the second reference signal to UE 530, reflected via the RIS 540. As shown by reference number 820, UE 520 may also transmit a third reference signal to UE 530. This may be a LoS reference signal that is not reflected by RIS 540. As shown by reference number 825, UE 530 may obtain a second measurement. This may involve subtracting the third reference signal from the second reference signal, where the second reference signal and the third reference signal are distinguishable.

As shown by reference number 830, the base station 510 may transmit a fourth reference signal to UE 530 via the RIS 540. As shown by reference number 835, UE 530 may obtain a third measurement. As shown by reference number 840, UE 520 may transmit the first measurement. As shown by reference number 845, UE 530 may transmit the second measurement and the third measurement. The base station 510 may calculate a path loss and/or a rank for each link.

As shown by reference number 850, the base station 510 may generate a scheduling message based at least in part on the path losses and/or ranks for the individual links. As shown by reference number 855, the base station 510 may transmit the scheduling message to UE 520 or UE 530. The scheduling message may indicate which links to use and/or whether the RIS 540 is to be involved in transmitting a communication. The scheduling message may help to avoid a blocked or degraded link. The scheduling message may also adjust beam sweeping to be more efficient.

As indicated above, FIG. 8 is provided as an example. Other examples may differ from what is described with regard to FIG. 8.

FIG. 9 is a diagram illustrating an example process 900 performed, for example, by a receiving UE, in accordance with the present disclosure. Example process 900 is an example where the receiving UE (e.g., UE 120, UE 530) performs operations associated with measurement of links associated with a passive device.

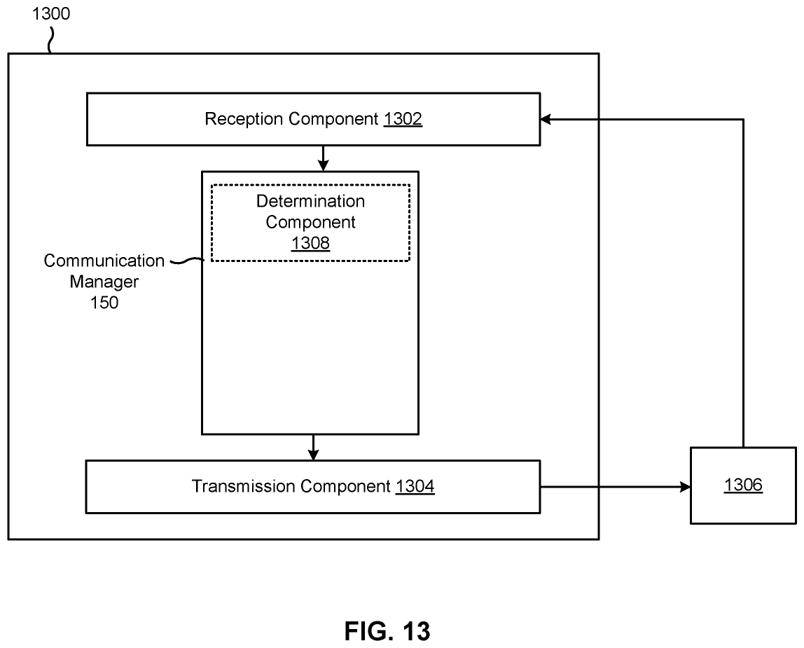

As shown in FIG. 9, in some aspects, process 900 may include transmitting a first measurement that is based at least in part on a first reference signal, from a base station, that is to be reflected via a passive device (block 910). For example, the receiving UE (e.g., using communication manager 150 and/or transmission component 1304 depicted in FIG. 13) may transmit a first measurement that is based at least in part on a first reference signal, from a base station, that is to be reflected via a passive device, as described above.

As further shown in FIG. 9, in some aspects, process 900 may include transmitting a second measurement that is based at least in part on a second reference signal, from a transmitting UE, that is to be reflected via the passive device and a third reference signal from the transmitting UE (block 920). For example, the receiving UE (e.g., using communication manager 150 and/or transmission component 1304 depicted in FIG. 13) may transmit a second measurement that is based at least in part on a second reference signal, from a transmitting UE, that is to be reflected via the passive device and a third reference signal from the transmitting UE, as described above.

Process 900 may include additional aspects, such as any single aspect or any combination of aspects described below and/or in connection with one or more other processes described elsewhere herein.

In a first aspect, the third reference signal is not reflected via the passive device. In a second aspect, alone or in combination with the first aspect, process 900 includes determining the second measurement based at least in part on subtracting the third reference signal from the second reference signal.

In a third aspect, alone or in combination with one or more of the first and second aspects, the third reference signal is received in a different slot or symbol than the second reference signal.

In a fourth aspect, alone or in combination with one or more of the first through third aspects, process 900 includes identifying the third reference signal based at least in part on the second reference signal being marked differently than the third reference signal.

In a fifth aspect, alone or in combination with one or more of the first through fourth aspects, the first measurement is a first path loss measurement and the second measurement is a second path loss measurement.

In a sixth aspect, alone or in combination with one or more of the first through fifth aspects, the first measurement is a first rank determination and the second measurement is a second rank determination.

In a seventh aspect, alone or in combination with one or more of the first through sixth aspects, process 900 includes determining the first rank determination or the second rank determination based at least in part on a threshold ratio of eigenvalues.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a transmitting UE, in accordance with the present disclosure. Example process 1000 is an example where the transmitting UE (e.g., UE 120, UE 520) performs operations associated with measurement of links associated with a passive device.

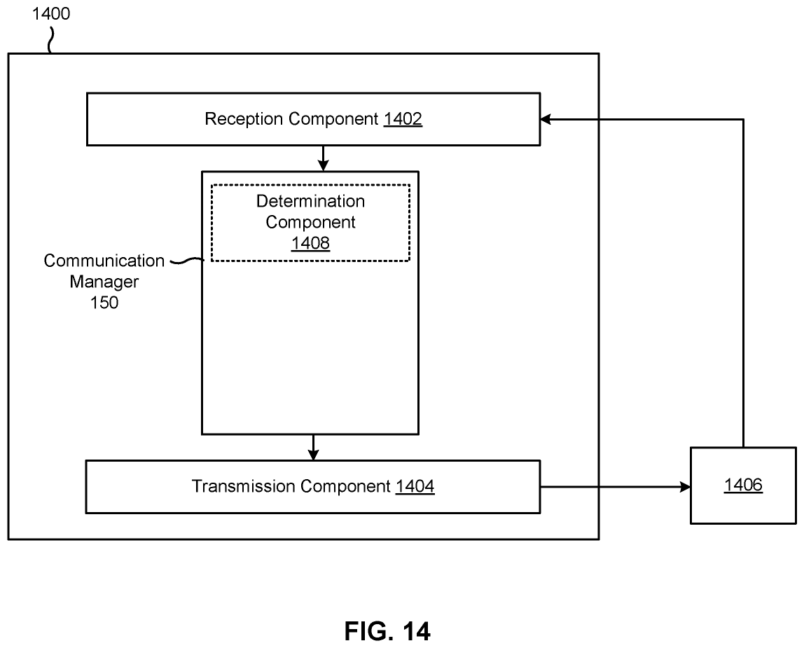

As shown in FIG. 10, in some aspects, process 1000 may include transmitting a first measurement that is based at least in part on a first reference signal, from a base station, that is reflected via a passive device (block 1010). For example, the transmitting UE (e.g., using communication manager 150 and/or transmission component 1404 depicted in FIG. 14) may transmit a first measurement that is based at least in part on a first reference signal, from a base station, that is reflected via a passive device, as described above.

As further shown in FIG. 10, in some aspects, process 1000 may include transmitting, in connection with a request from the base station, a second reference signal, to a receiving UE, that is to be reflected via the passive device (block 1020). For example, the UE (e.g., using communication manager 150 and/or transmission component 1404 depicted in FIG. 14) may transmit, in connection with a request from the base station, a second reference signal, to a receiving UE, that is to be reflected via the passive device, as described above.

As further shown in FIG. 10, in some aspects, process 1000 may include transmitting, in connection with the request, a third reference signal to the receiving UE (block 1030). For example, the UE (e.g., using communication manager 150 and/or transmission component 1404 depicted in FIG. 14) may transmit, in connection with the request, a third reference signal to the receiving UE, as described above.

Process 1000 may include additional aspects, such as any single aspect or any combination of aspects described below and/or in connection with one or more other processes described elsewhere herein.

In a first aspect, transmitting the third reference signal includes transmitting the third reference signal in a different slot or symbol than the second reference signal.

In a second aspect, alone or in combination with the first aspect, the first measurement is a first path loss measurement.

In a third aspect, alone or in combination with one or more of the first and second aspects, the first measurement is a first rank determination.

In a fourth aspect, alone or in combination with one or more of the first through third aspects, process 1000 includes determining the first rank determination based at least in part on a threshold ratio of eigenvalues.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110, base station 510) performs operations associated with measurement of links associated with a passive device.

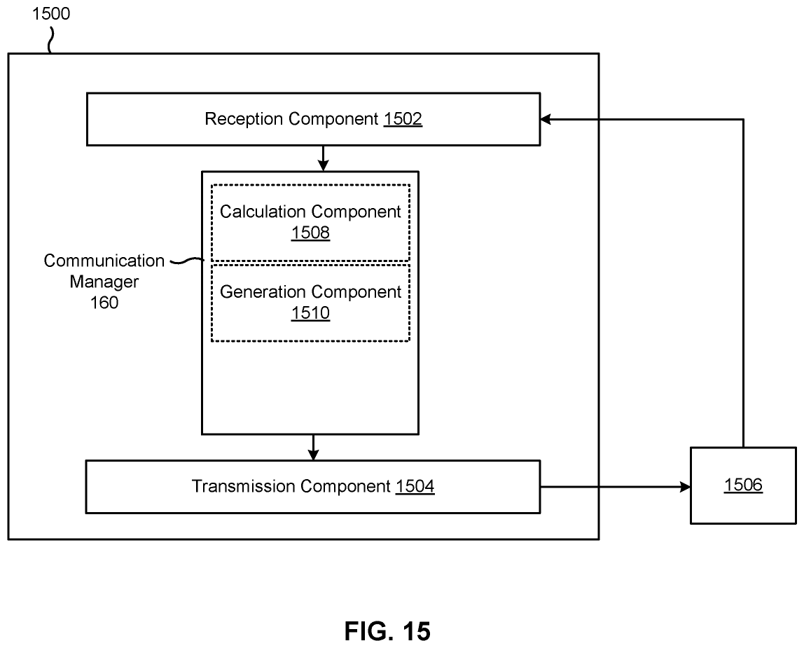

As shown in FIG. 11, in some aspects, process 1100 may include transmitting, to a transmitting UE, a first reference signal that is to be reflected via a passive device and a request for the transmitting UE to transmit, to a receiving UE, a second reference signal that is to be reflected via the passive device (block 1110). For example, the base station (e.g., using communication manager 160 and/or transmission component 1504 depicted in FIG. 15) may transmit, to a transmitting UE, a first reference signal that is to be reflected via a passive device and a request for the transmitting UE to transmit, to a receiving UE, a second reference signal that is to be reflected via the passive device, as described above.

As further shown in FIG. 11, in some aspects, process 1100 may include transmitting, to the receiving UE, a third reference signal that is to be reflected via the passive device (block 1120). For example, the base station (e.g., using communication manager 160 and/or transmission component 1504 depicted in FIG. 15) may transmit, to the receiving UE, a third reference signal that is to be reflected via the passive device, as described above.

As further shown in FIG. 11, in some aspects, process 1100 may include receiving a first measurement from the transmitting UE for the first reference signal, a second measurement from the receiving UE for the second reference signal, and a third measurement from the receiving UE for the third reference signal (block 1130). For example, the base station (e.g., using communication manager 160 and/or reception component 1502 depicted in FIG. 15) may receive a first measurement from the transmitting UE for the first reference signal, a second measurement from the receiving UE for the second reference signal, and a third measurement from the receiving UE for the third reference signal, as described above.

As further shown in FIG. 11, in some aspects, process 1100 may include transmitting a scheduling message to the transmitting UE or the receiving UE that is based at least in part on the first measurement, the second measurement, and the third measurement (block 1140). For example, the base station (e.g., using communication manager 150 and/or transmission component 1504 depicted in FIG. 15) may transmit a scheduling message to the transmitting UE or the receiving UE that is based at least in part on the first measurement, the second measurement, and the third measurement, as described above.

Process 1100 may include additional aspects, such as any single aspect or any combination of aspects described below and/or in connection with one or more other processes described elsewhere herein.

In a first aspect, the first measurement is a first path loss measurement, the second measurement is a second path loss measurement, and the third measurement is a third path loss measurement.

In a second aspect, alone or in combination with the first aspect, process 1100 includes calculating, from the first path loss measurement, the second path loss measurement, and the third path loss measurement a first path loss over a first link between the base station and the passive device, a second path loss over a second link between the passive device and the transmitting UE, and a third path loss over a third link between the passive device and the receiving UE.

In a third aspect, alone or in combination with one or more of the first and second aspects, process 1100 includes generating the scheduling message for the transmitting UE based at least in part on the second path loss.

In a fourth aspect, alone or in combination with one or more of the first through third aspects, process 1100 includes generating the scheduling message for the receiving UE based at least in part on the third path loss.

In a fifth aspect, alone or in combination with one or more of the first through fourth aspects, the first measurement is a first rank determination, the second measurement is a second rank determination, and the third measurement is a third rank determination.

In a sixth aspect, alone or in combination with one or more of the first through fifth aspects, process 1100 includes calculating, from the first rank determination, the second rank determination, and the third rank determination a first rank over a first link between the base station and the passive device, a second rank over a second link between the passive device and the transmitting UE, and a third rank over a third link between the passive device and the receiving UE.

In a seventh aspect, alone or in combination with one or more of the first through sixth aspects, process 1100 includes generating the scheduling message for the transmitting UE based at least in part on the second rank over the second link.

In an eighth aspect, alone or in combination with one or more of the first through seventh aspects, process 1100 includes generating the scheduling message for the receiving UE based at least in part on the third rank over the third link.

In a ninth aspect, alone or in combination with one or more of the first through eighth aspects, process 1100 includes determining a reflection path loss for the passive device based at least in part on the first measurement, the second measurement, and the third measurement.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a passive device, in accordance with the present disclosure. Example process 1200 is an example where the passive device (e.g., RIS 540) performs operations associated with measurement of links associated with a passive device.

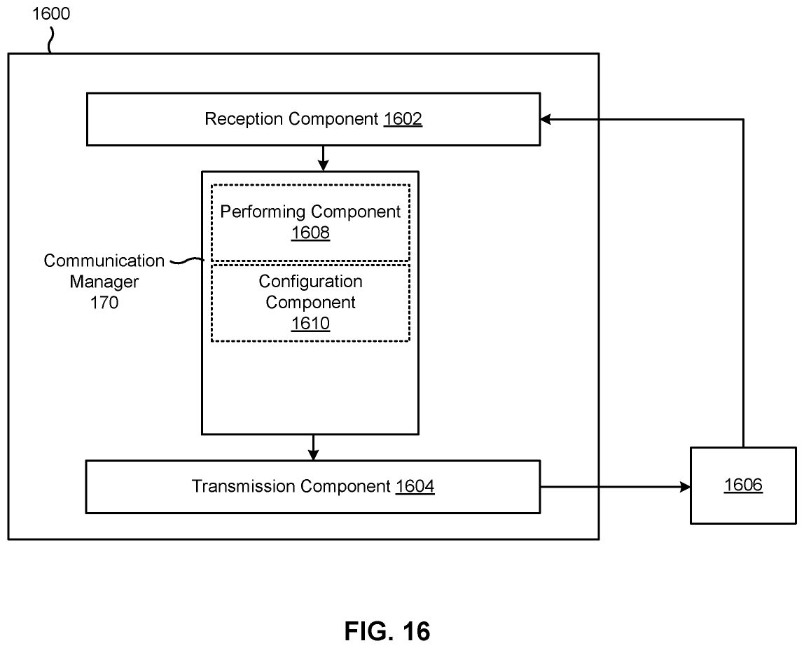

As shown in FIG. 12, in some aspects, process 1200 may include receiving, from a base station, a first reflection configuration for a first link between the base station and the passive device (block 1210). For example, the passive device (e.g., using communication manager 170 and/or reception component 1602 depicted in FIG. 16) may receive, from a base station, a first reflection configuration for a first link between the base station and the passive device, as described above.

As further shown in FIG. 12, in some aspects, process 1200 may include performing beam sweeping to determine a second reflection configuration for a second link between the passive device and a transmitting UE and to determine a third reflection configuration for a third link between the passive device and a receiving UE (block 1220). For example, the passive device (e.g., using communication manager 170 and/or performing component 1608 depicted in FIG. 16) may perform beam sweeping to determine a second reflection configuration for a second link between the passive device and a transmitting UE and to determine a third reflection configuration for a third link between the passive device and a receiving UE, as described above.

As further shown in FIG. 12, in some aspects, process 1200 may include determining a fourth reflection configuration for reflection between the transmitting UE and the receiving UE based at least in part on the second reflection configuration and the third reflection configuration (block 1230). For example, the passive device (e.g., using communication manager 170 and/or configuration component 1610 depicted in FIG. 16) may determine a fourth reflection configuration for reflection between the transmitting UE and the receiving UE based at least in part on the second reflection configuration and the third reflection configuration, as described above.

As further shown in FIG. 12, in some aspects, process 1200 may include reflecting, using the fourth reflection configuration, a first reference signal from the transmitting UE to the receiving UE (block 1240). For example, the passive device (e.g., using communication manager 170 and/or configuration component 1610 depicted in FIG. 16) may reflect, using the fourth reflection configuration, a first reference signal from the transmitting UE to the receiving UE, as described above.

Process 1200 may include additional aspects, such as any single aspect or any combination of aspects described below and/or in connection with one or more other processes described elsewhere herein.

In a first aspect, the passive device is a RIS.

In a second aspect, alone or in combination with the first aspect, reflecting the first reference signal includes activating, for a first slot or symbol, reflection for the first reference signal, and deactivating, for another slot or symbol, reflection for a second reference signal from the transmitting UE to the receiving UE.

In a third aspect, alone or in combination with one or more of the first and second aspects, process 1200 includes marking the first reference signal such that the first reference signal is distinguishable from a second reference signal from the transmitting UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a receiving UE (e.g., UE 530), or a receiving UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may a determination component 1308, among other examples.

In some aspects, the apparatus 1300 may be configured to perform one or more operations described herein in connection with FIGS. 1-8. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the receiving UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the receiving UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the receiving UE described in connection with FIG. 2. In some aspects, the transmission component 1304 may be co-located with the reception component 1302 in a transceiver.

The transmission component 1304 may transmit a first measurement that is based at least in part on a first reference signal, from a base station, that is to be reflected via a passive device. The transmission component 1304 may transmit a second measurement that is based at least in part on a second reference signal, from a transmitting UE, that is to be reflected via the passive device and a third reference signal from the transmitting UE.

The determination component 1308 may determine the second measurement based at least in part on subtracting the third reference signal from the second reference signal. The determination component 1308 may identify the third reference signal based at least in part on the second reference signal being marked differently than the third reference signal. The determination component 1308 may determine the first rank determination or the second rank determination based at least in part on a threshold ratio of eigenvalues.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a transmitting UE (e.g., UE 520), or a transmitting UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a determination component 1408, among other examples.

In some aspects, the apparatus 1400 may be configured to perform one or more operations described herein in connection with FIGS. 1-8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the transmitting UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the transmitting UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the transmitting UE described in connection with FIG. 2. In some aspects, the transmission component 1404 may be co-located with the reception component 1402 in a transceiver.

The transmission component 1404 may transmit a first measurement that is based at least in part on a first reference signal, from a base station, that is reflected via a passive device. The transmission component 1404 may transmit, in connection with a request from the base station, a second reference signal, to a receiving UE, that is to be reflected via the passive device. The transmission component 1404 may transmit, in connection with the request, a third reference signal to the receiving UE. The determination component 1408 may determine the first rank determination based at least in part on a threshold ratio of eigenvalues.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a base station (e.g., base station 510), or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 160. The communication manager 160 may include a calculation component 1508 and/or a generation component 1510, among other examples.

In some aspects, the apparatus 1500 may be configured to perform one or more operations described herein in connection with FIGS. 1-8. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the base station described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the base station described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the base station described in connection with FIG. 2. In some aspects, the transmission component 1504 may be co-located with the reception component 1502 in a transceiver.

The transmission component 1504 may transmit, to a transmitting UE, a first reference signal that is to be reflected via a passive device and a request for the transmitting UE to transmit, to a receiving UE, a second reference signal that is to be reflected via the passive device. The transmission component 1504 may transmit, to the receiving UE, a third reference signal that is to be reflected via the passive device. The reception component 1502 may receive a first measurement from the transmitting UE for the first reference signal, a second measurement from the receiving UE for the second reference signal, and a third measurement from the receiving UE for the third reference signal. The transmission component 1504 may transmit a scheduling message to the transmitting UE or the receiving UE that is based at least in part on the first measurement, the second measurement, and the third measurement.

The calculation component 1508 may calculate, from the first path loss measurement, the second path loss measurement, and the third path loss measurement a first path loss over a first link between the base station and the passive device; a second path loss over a second link between the passive device and the transmitting UE; and a third path loss over a third link between the passive device and the receiving UE.

The generation component 1510 may generate the scheduling message for the transmitting UE based at least in part on the second path loss. The generation component 1510 may generate the scheduling message for the receiving UE based at least in part on the third path loss.

The calculation component 1508 may calculate, from the first rank determination, the second rank determination, and the third rank determination a first rank over a first link between the base station and the passive device; a second rank over a second link between the passive device and the transmitting UE; and a third rank over a third link between the passive device and the receiving UE.

The generation component 1510 may generate the scheduling message for the transmitting UE based at least in part on the second rank over the second link. The generation component 1510 may generate the scheduling message for the receiving UE based at least in part on the third rank over the third link. The calculation component 1508 may determine a reflection path loss for the passive device based at least in part on the first measurement, the second measurement, and the third measurement.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a passive device (e.g., RIS 540), or a passive device may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 170. The communication manager 170 may include a performing component 1608 and/or a configuration component 1610, among other examples.

In some aspects, the apparatus 1600 may be configured to perform one or more operations described herein in connection with FIGS. 1-8. Additionally, or alternatively, the apparatus 1600 may be configured to perform one or more processes described herein, such as process 1200 of FIG. 12. In some aspects, the apparatus 1600 and/or one or more components shown in FIG. 16 may include one or more components of the passive device described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the passive device described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the passive device described in connection with FIG. 2. In some aspects, the transmission component 1604 may be co-located with the reception component 1602 in a transceiver.

The reception component 1602 may receive, from a base station, a first reflection configuration for a first link between the base station and the passive device. The performing component 1608 may perform beam sweeping to determine a second reflection configuration for a second link between the passive device and a transmitting UE and to determine a third reflection configuration for a third link between the passive device and a receiving UE. The configuration component 1610 may determine a fourth reflection configuration for reflection between the transmitting UE and the receiving UE based at least in part on the second reflection configuration and the third reflection configuration. The configuration component 1610 may reflect, using the fourth reflection configuration, a first reference signal from the transmitting UE to the receiving UE. The configuration component 1610 may mark the first reference signal such that the first reference signal is distinguishable from a second reference signal from the transmitting UE.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a receiving user equipment (UE), comprising: transmitting a first measurement that is based at least in part on a first reference signal, from a base station, that is to be reflected via a passive device; and transmitting a second measurement that is based at least in part on a second reference signal, from a transmitting UE, that is to be reflected via the passive device and a third reference signal from the transmitting UE.

Aspect 2: The method of Aspect 1, wherein the third reference signal is not reflected via the passive device.

Aspect 3: The method of Aspect 1 or 2, further comprising determining the second measurement based at least in part on subtracting the third reference signal from the second reference signal.

Aspect 4: The method of any of Aspects 1-3, wherein the third reference signal is received in a different slot or symbol than the second reference signal.

Aspect 5: The method of any of Aspects 1-4, further comprising identifying the third reference signal based at least in part on the second reference signal being marked differently than the third reference signal.

Aspect 6: The method of any of Aspects 1-5, wherein the first measurement is a first path loss measurement and the second measurement is a second path loss measurement.

Aspect 7: The method of any of Aspects 1-5, wherein the first measurement is a first rank determination and the second measurement is a second rank determination.

Aspect 8: The method of Aspect 7, further comprising determining the first rank determination or the second rank determination based at least in part on a threshold ratio of eigenvalues.

Aspect 9: A method of wireless communication performed by a transmitting user equipment (UE), comprising: transmitting a first measurement that is based at least in part on a first reference signal, from a base station, that is reflected via a passive device; transmitting, in connection with a request from the base station, a second reference signal, to a receiving UE, that is to be reflected via the passive device; and transmitting, in connection with the request, a third reference signal to the receiving UE.

Aspect 10: The method of Aspect 9, wherein transmitting the third reference signal includes transmitting the third reference signal in a different slot or symbol than the second reference signal.

Aspect 11: The method of Aspect 9 or 10, wherein the first measurement is a first path loss measurement.

Aspect 12: The method of Aspect 9 or 10, wherein the first measurement is a first rank determination.

Aspect 13: The method of Aspect 12, further comprising determining the first rank determination based at least in part on a threshold ratio of eigenvalues.

Aspect 14: A method of wireless communication performed by a base station, comprising: transmitting, to a transmitting user equipment (UE), a first reference signal that is to be reflected via a passive device and a request for the transmitting UE to transmit, to a receiving UE, a second reference signal that is to be reflected via the passive device; transmitting, to the receiving UE, a third reference signal that is to be reflected via the passive device; receiving a first measurement from the transmitting UE for the first reference signal, a second measurement from the receiving UE for the second reference signal, and a third measurement from the receiving UE for the third reference signal; and transmitting a scheduling message to the transmitting UE or the receiving UE that is based at least in part on the first measurement, the second measurement, and the third measurement.

Aspect 15: The method of Aspect 14, wherein the first measurement is a first path loss measurement, the second measurement is a second path loss measurement, and the third measurement is a third path loss measurement.

Aspect 16: The method of Aspect 15, further comprising calculating, from the first path loss measurement, the second path loss measurement, and the third path loss measurement: a first path loss over a first link between the base station and the passive device; a second path loss over a second link between the passive device and the transmitting UE; and a third path loss over a third link between the passive device and the receiving UE.

Aspect 17: The method of Aspect 16, further comprising generating the scheduling message for the transmitting UE based at least in part on the second path loss.

Aspect 18: The method of Aspect 16 or 17, further comprising generating the scheduling message for the receiving UE based at least in part on the third path loss.

Aspect 19: The method of Aspect 14, wherein the first measurement is a first rank determination, the second measurement is a second rank determination, and the third measurement is a third rank determination.

Aspect 20: The method of Aspect 19, further comprising calculating, from the first rank determination, the second rank determination, and the third rank determination: a first rank over a first link between the base station and the passive device; a second rank over a second link between the passive device and the transmitting UE; and a third rank over a third link between the passive device and the receiving UE.

Aspect 21: The method of Aspect 20, further comprising generating the scheduling message for the transmitting UE based at least in part on the second rank over the second link.

Aspect 22: The method of Aspect 20, further comprising generating the scheduling message for the receiving UE based at least in part on the third rank over the third link.

Aspect 23: The method of Aspect 14, further comprising determining a reflection path loss for the passive device based at least in part on the first measurement, the second measurement, and the third measurement.

Aspect 24: A method of wireless communication performed by a passive device, comprising: receiving, from a base station, a first reflection configuration for a first link between the base station and the passive device; performing beam sweeping to determine a second reflection configuration for a second link between the passive device and a transmitting user equipment (UE) and to determine a third reflection configuration for a third link between the passive device and a receiving UE;

determining a fourth reflection configuration for reflection between the transmitting UE and the receiving UE based at least in part on the second reflection configuration and the third reflection configuration; and reflecting, using the fourth reflection configuration, a first reference signal from the transmitting UE to the receiving UE.

Aspect 25: The method of Aspect 24, wherein the passive device is a RIS.

Aspect 26: The method of Aspect 24 or 25, wherein reflecting the first reference signal includes: activating, for a first slot or symbol, reflection for the first reference signal; and deactivating, for another slot or symbol, reflection for a second reference signal from the transmitting UE to the receiving UE.

Aspect 27: The method of any of Aspects 24-26, further comprising marking the first reference signal such that the first reference signal is distinguishable from a second reference signal from the transmitting UE.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A receiving user equipment (UE) for wireless communication, comprising:
a memory; and
one or more processors, coupled to the memory, configured to:
transmit a first measurement that is based at least in part on a first reference signal, from a base station, that is to be reflected via a passive device; and
transmit a second measurement that is based at least in part on a second reference signal, from a transmitting UE, that is to be reflected via the passive device and a third reference signal from the transmitting UE.

2. The receiving UE of claim 1, wherein the third reference signal is not reflected via the passive device.

3. The receiving UE of claim 1, wherein the one or more processors are configured to determine the second measurement based at least in part on subtracting the third reference signal from the second reference signal.

4. The receiving UE of claim 1, wherein the third reference signal is received in a different slot or symbol than the second reference signal.

5. The receiving UE of claim 1, wherein the one or more processors are configured to identify the third reference signal based at least in part on the second reference signal being marked differently than the third reference signal.

6. The receiving UE of claim 1, wherein the first measurement is a first path loss measurement and the second measurement is a second path loss measurement.

7. The receiving UE of claim 1, wherein the first measurement is a first rank determination and the second measurement is a second rank determination.

8. The receiving UE of claim 7, wherein the one or more processors are configured to determine the first rank determination or the second rank determination based at least in part on a threshold ratio of eigenvalues.

9. A transmitting user equipment (UE) for wireless communication, comprising:
a memory; and
one or more processors, coupled to the memory, configured to:
transmit a first measurement that is based at least in part on a first reference signal, from a base station, that is reflected via a passive device;
transmit, in connection with a request from the base station, a second reference signal, to a receiving UE, that is to be reflected via the passive device; and
transmit, in connection with the request, a third reference signal to the receiving UE.

10. The transmitting UE of claim 9, wherein the one or more processors, to transmit the third reference signal, are configured to transmit the third reference signal in a different slot or symbol than the second reference signal.

11. The transmitting UE of claim 9, wherein the first measurement is a first path loss measurement.

12. The transmitting UE of claim 9, wherein the first measurement is a first rank determination.

13. The transmitting UE of claim 12, wherein the one or more processors are configured to determine the first rank determination based at least in part on a threshold ratio of eigenvalues.

14. A base station for wireless communication, comprising:
a memory; and
one or more processors, coupled to the memory, configured to:
transmit, to a transmitting user equipment (UE), a first reference signal that is to be reflected via a passive device and a request for the transmitting UE to transmit, to a receiving UE, a second reference signal that is to be reflected via the passive device;
transmit, to the receiving UE, a third reference signal that is to be reflected via the passive device;
receive a first measurement from the transmitting UE for the first reference signal, a second measurement from the receiving UE for the second reference signal, and a third measurement from the receiving UE for the third reference signal; and
transmit a scheduling message to the transmitting UE or the receiving UE that is based at least in part on the first measurement, the second measurement, and the third measurement.

15. The base station of claim 14, wherein the first measurement is a first path loss measurement, the second measurement is a second path loss measurement, and the third measurement is a third path loss measurement.

16. The base station of claim 15, wherein the one or more processors are configured to calculate, from the first path loss measurement, the second path loss measurement, and the third path loss measurement:
a first path loss over a first link between the base station and the passive device;
a second path loss over a second link between the passive device and the transmitting UE; and
a third path loss over a third link between the passive device and the receiving UE.

17. The base station of claim 16, wherein the one or more processors are configured to generate the scheduling message for the transmitting UE based at least in part on the second path loss.

18. The base station of claim 16, wherein the one or more processors are configured to generate the scheduling message for the receiving UE based at least in part on the third path loss.

19. The base station of claim 14, wherein the first measurement is a first rank determination, the second measurement is a second rank determination, and the third measurement is a third rank determination.

20. The base station of claim 19, wherein the one or more processors are configured to calculate, from the first rank determination, the second rank determination, and the third rank determination:
a first rank over a first link between the base station and the passive device;
a second rank over a second link between the passive device and the transmitting UE; and
a third rank over a third link between the passive device and the receiving UE.

21. The base station of claim 20, wherein the one or more processors are configured to generate the scheduling message for the transmitting UE based at least in part on the second rank over the second link.

22. The base station of claim 20, wherein the one or more processors are configured to generate the scheduling message for the receiving UE based at least in part on the third rank over the third link.

23. The base station of claim 14, wherein the one or more processors are configured to determine a reflection path loss for the passive device based at least in part on the first measurement, the second measurement, and the third measurement.

24. A passive device for wireless communication, comprising:
a memory; and
one or more processors, coupled to the memory, configured to:
receive, from a base station, a first reflection configuration for a first link between the base station and the passive device;
perform beam sweeping to determine a second reflection configuration for a second link between the passive device and a transmitting user equipment (UE) and to determine a third reflection configuration for a third link between the passive device and a receiving UE;
determine a fourth reflection configuration for reflection between the transmitting UE and the receiving UE based at least in part on the second reflection configuration and the third reflection configuration; and
reflect, using the fourth reflection configuration, a first reference signal from the transmitting UE to the receiving UE.

25. The passive device of claim 24, wherein the passive device is a reconfigurable intelligent surface.

26. The passive device of claim 24, wherein the one or more processors, to reflect the first reference signal, are configured to:
activate, for a first slot or symbol, reflection for the first reference signal; and
deactivate, for another slot or symbol, reflection for a second reference signal from the transmitting UE to the receiving UE.

27. The passive device of claim 24, wherein the one or more processors are configured to mark the first reference signal such that the first reference signal is distinguishable from a second reference signal from the transmitting UE.
